(19) United States
(12) Patent Application Publication
(10) Pub. No.: US 2017/0012483 A1
(43) Pub. Date: Jan. 12, 2017

(54) Electromagnetic Motor Patent

(71) Applicant: Teofil Tony Toma, Redlands, CA (US)

(72) Inventor: Teofil Tony Toma, Redlands, CA (US)

(21) Appl. No.: 14/794,809

(22) Filed: Jul. 9, 2015

(51) Int. Cl. H02K 3/28; H02K 9/19

(52) U.S. Cl. CPC H02K 3/28; H02K 9/19

(57) ABSTRACT

There are several concepts that I am trying to receive a patent for in this application. All of these concepts are related to making an improved Electromagnetic Motor. These concepts can apply to both AC & DC electro magnetic motors. This Electromagnetic Motor utilizes permanent magnets arranged in cylindrical shells. Instead of using copper conductors, this design uses Ferro Magnetic Conductors. Like the Magnetic Shells, the Conductors are also arranged in cylindrical shells. The Conductor Shells are sandwiched between the Magnetic Shells. The principle is very simple. The Conductor itself aids in maintaining and perpetuating the Magnetic Field created by the Permanent Magnets in the Magnetic Shells. The Magnetic Shells are yoked together which will slightly help in enhancing the Magnetic Field, but the geometric arrangement of the magnetic shells and conductor shells is what will add the greatest contribution to the overall motor design. This geometric configuration allows the gap spacing between the Permanent Magnet Shell Pairs to be minimized, greatly increasing the magnetic field at the conductor level.

### DESCRIPTION OF FIGURES

application Ser. No. 14/794,809

FIG. 1: Basic Motor Layout:

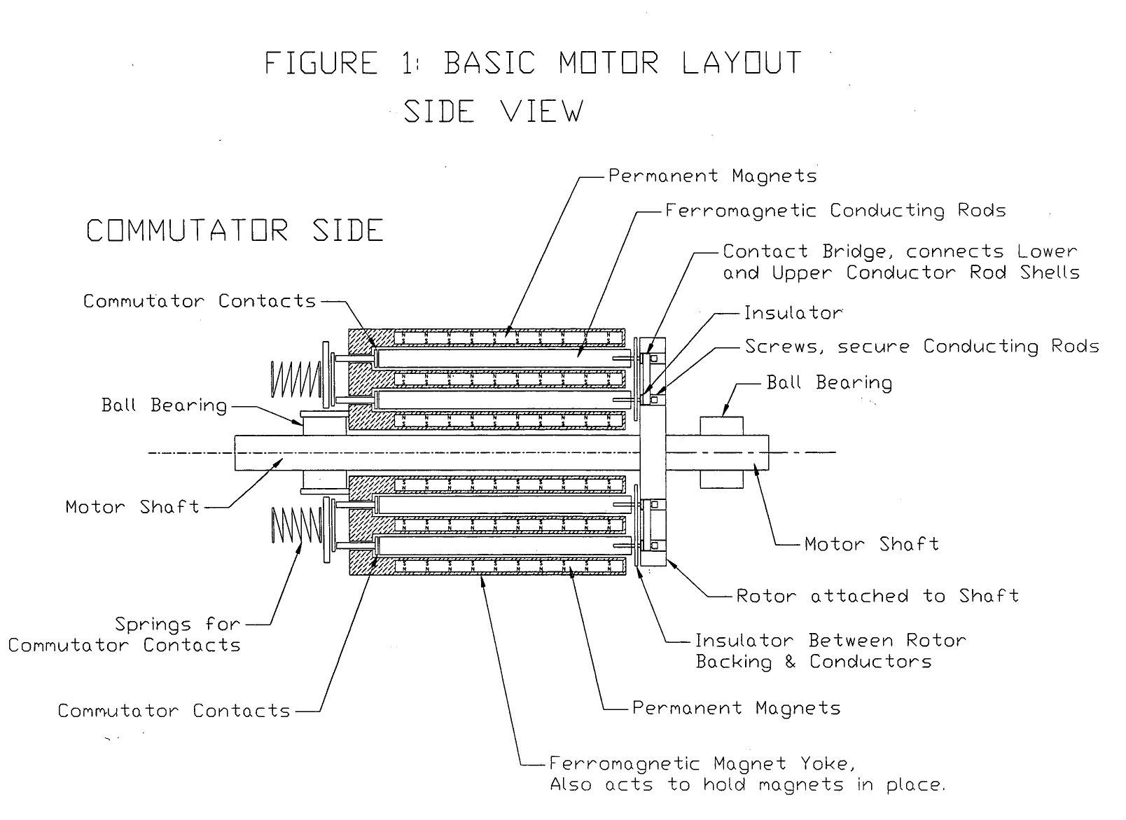

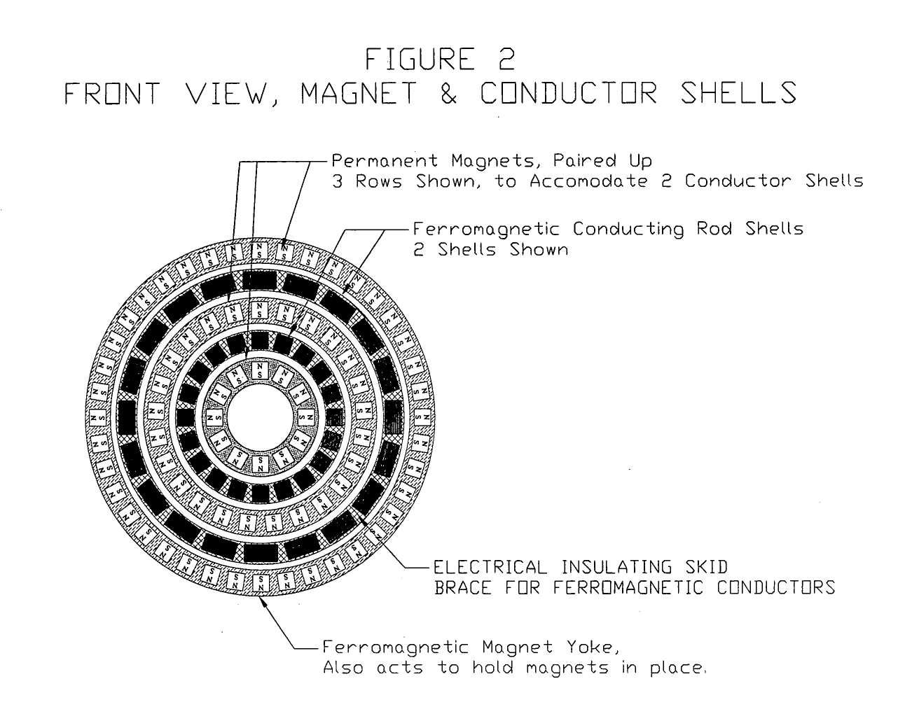

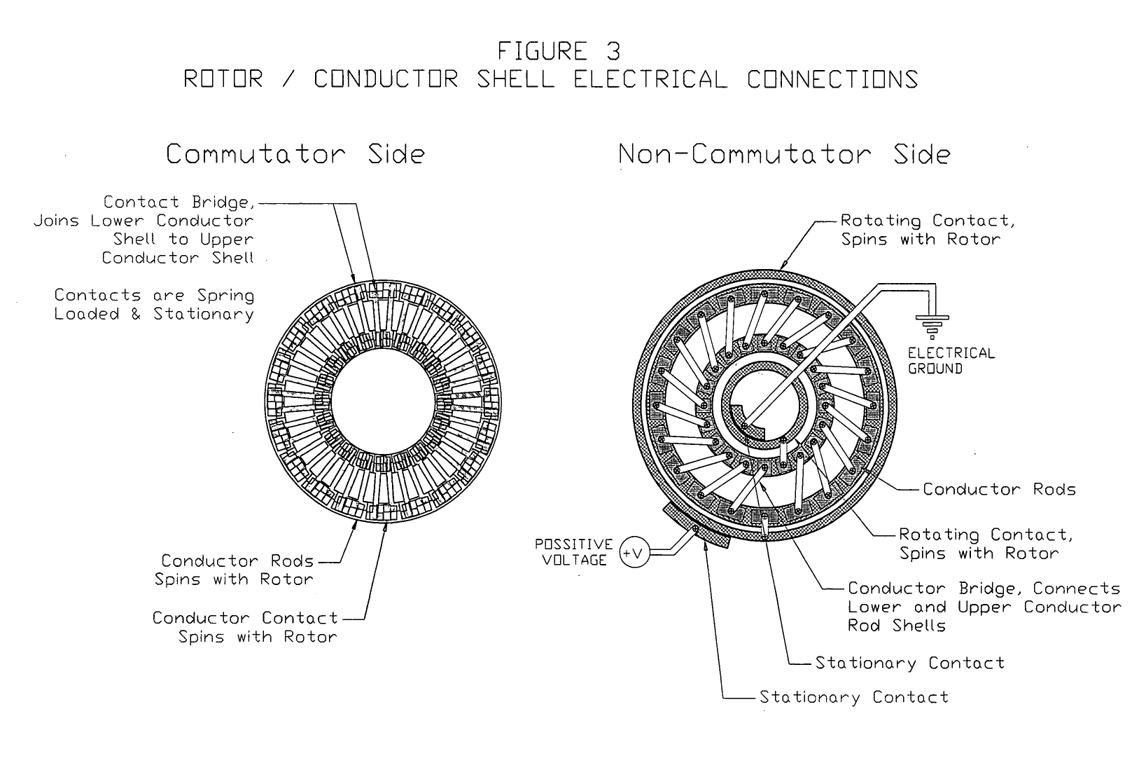

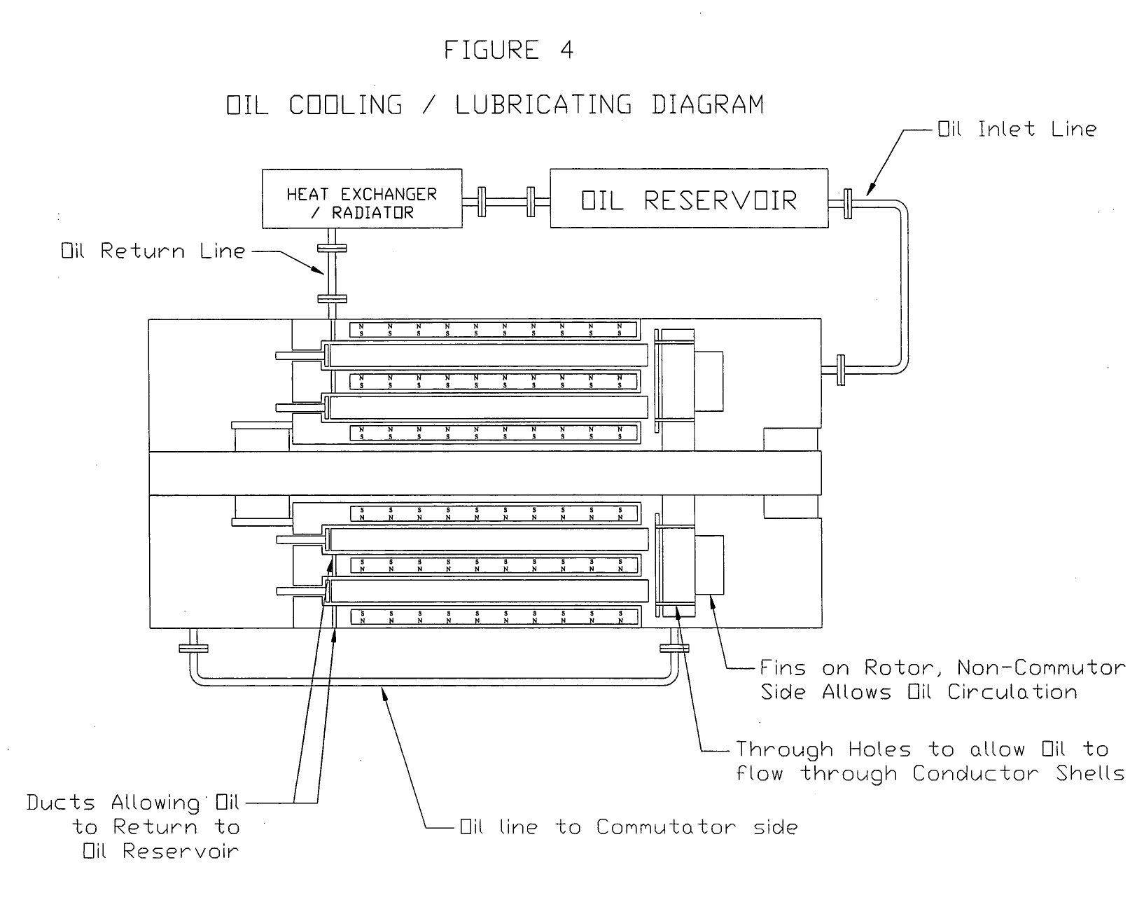

This figure shows the basic mechanical layout of the motor. The rotor is unique from the conventional electromagnetic motor. It is made up of several components mechanically attached together, namely a Structural Plate attached to the motor shaft, and a series of Conductor Shells, 2 are shown in the diagram. The Conductor Shells are made up of multiple numbers of Ferro-Magnetic rods, insulated electrically from each other, arranged in a cylindrical shape. The Shells are mechanically mounted to the Structural Plate of the rotor.

The Conductor Shells are also made very thin, about 0.1″, 2.5 mm, thick, and sandwiched between opposing Magnetic Shells. The Magnetic Shells are also spaced apart as to minimize the space between them, maximizing the magnetic field in the electrical conducting path. Minimizing the spacing between the Magnetic Shells, maximizes the strength of the internal Magnetic Field.

The Magnetic Shells are made up of multiple smaller Neodymium Magnets mounted on a Ferro-Magnetic Frame. The Ferro-Magnetic Frame will act as a yoke for the magnets. Although it is believed the Ferro-Magnetic Frame will improve the internal magnetic field strength, it is the closely packed geometric Magnetic Shell configuration that will provide the greatest benefit to the magnetic field strength.

Since the Electrical Conductors are Magnetic, the Magnetic Field will be greatly enhanced in the current path, where it is most beneficial to the overall performance of the electric motor. For simplicity, only 2 Conductor Shells are shown. In the practical sense, multiple shells would be used, typically 10-20.

One end of the Conductor Shells is hard mounted to the Rotor's Structural Plate. Each individual Conductor Rod is electrically insulated from the Rotor's Structural Plate. The other end is connected electrically to the Commutator via spring loaded contacts.

### FIG. 2: Magnet & Conductor Shells:

This figure shows a generic 2 Electrical Conductor Shell configuration. As stated above, in the practical sense, multiple shells would be used, 10-20 typically. The Conductor Shells are sandwiched between the Magnetic Shells. Each shell is made up of much smaller individual Conducting Rods and Permanent Magnets respectively.

### FIG. 3: Electrical Connections of the Conductor Shells:

This figure shows the electrical current path through the Conductor Rods. The two Conductor Shells, with their respective Conductor Rods, make up one large winding, surrounding a Magnetic Shell, and enclosed within two other Magnetic Shells. Note, for simplicity, only One Pair of Conductor Shells are shown. In the practical case, 5-10 pairs would be used.

The Current starts at the Positive Voltage Terminal, which is in contact with the larger cylindrical rotating Contact. This Contact spins with the rotor, and is electrically connected to the first Conducting Rod, on the larger outer Conductor Shell, as shown in the diagram. The current travels through this first rod, into the page, then travels up the contacts on the Commutator Side, making contact with the Conductor Rod on the inner Conductor Shell. The contacts on the Commutator Side are stationary. There are 2 contacts per Conductor Rod. As the Rotor Spins, these 2 Conductor Rods are always in electrical contact with each other. This functionality is possible because there are 2 contacts per Conductor Rod.

The current then passes through the Conductor Rod on the Inner Conductor Shell, up out of the page, and returns to the Non-Commutator Side of the motor. It is then passed to the next Conductor Rod, to the left of the first, via the Conductor bridge, and the process starts over. The last Conductor Rod, on the Inner Conductor Shell is connected to Electrical Ground, where the current path ends.

Like with the starting point, this contact is also made via a Rotating and stationary contact.

### FIG. 4: Oil Cooling/Lubricating Diagram:

This Electro Magnetic Motor will use Oil to keep it cool, and lubricate the contacts. The motor will be completely enclosed and sealed. It will also utilize an internal impeller which will draw the oil from the reservoir, and circulate it through the internal parts. The Oil will then be passed through a Heat Exchanger/Radiator, and return to the Oil Reservoir.

1. Use of Ferro-Magnetic Conductors:
The claim is that in using Ferro-Magnetic Conductors or Windings, the Internal Magnetic Field around the Current Path will be greatly enhanced. Conductors are to be arranged in cylindrical shells, and sandwiched between a tightly fitted magnetic shell pairs.

2. Use of Yoked Magnetic Shells, surrounding the Conductors:
The claim is that placing the internal magnets in paired shells, and a yoked configuration will also greatly enhance the internal magnetic field. The geometric arrangement of the Magnetic Shells will generate a much greater magnetic field at the conductor path. The ferromagnetic yoke will also slightly contribute to the overall design.

3. Duel Contact rows on the Commutator:
The dual contact rows will allow a continuous unidirectional current flow without switching. The claim is that eliminating switching will produce a more efficient motor design.

4. Internal Oil Cooling:
The claim is that circulating oil internal to cool both the conductors and the magnets will prolong motor life, and allow much greater life under extreme loading situations. The oil will also act to lubricate the contacts.
